(19) United States
(12) Patent Application Publication
(10) Pub. No.: US 2007/0034466 A1
(43) Pub. Date: Feb. 15, 2007

(54) Asymmetrical intake damper valve

(75) Inventors: Johan Paesmans, Masselt (BE); Walter Spiritus, Sint Truiden (BE); Frank Gommans, Maastricht (NL); Michel Tuteleers, Glabbeck (BE)

Correspondence Address: HARNESS, DICKEY & PIERCE, P.L.C., P.O. BOX 828, BLOOMFIELD HILLS, MI, 48303, US

(73) Assignee: Tenneco Automotive Operating Company, Inc., Lake Forest, IL (US)

(21) Appl. No.: 11/493,994

(22) Filed: Jul. 27, 2006

Related U.S. Application Data
(60) Provisional application No. 60/708,354, filed on Aug. 15, 2005.

(51) Int. Cl. F16F 9/00

(52) U.S. Cl. 188/322.22

(57) ABSTRACT

A valve assembly progressively opens to provide a smooth transition from a closed position to an open position. The fluid pressure reacts against a valve plate in a non-symmetrical manner to progressively open the valve. The valve can include a plurality of varying sized fluid passages or valve lands can be positioned eccentrically to each other to provide a non-symmetrical pressure area.

### CROSS-REFERENCE TO RELATED APPLICATIONS

This application claims the benefit of U.S. Provisional Application No. 60/708,354, filed on Aug. 15, 2005. The disclosure of the above application is incorporated herein by reference.

### FIELD

The present application/patent relates generally to hydraulic dampers or shock absorbers for use in a suspension system such as a suspension system used for automotive vehicles. More particularly, the present application/patent relates to an asymmetrical intake damper valve which reduces pressure oscillations related to the opening and closing of the valve.

### BACKGROUND

The statements in this section merely provide background information related to the present disclosure and may not constitute prior art.

Shock absorbers are used in conjunction with automotive suspension systems to absorb unwanted vibrations which occur during driving. To absorb the unwanted vibrations, shock absorbers are generally connected between the sprung portion (body) and the unsprung portion (suspension) of the automobile. A piston is located within a pressure tube of the shock absorber and the pressure tube is connected to the unsprung portion of the vehicle. The piston is connected to the sprung portion of the automobile through a piston rod which extends through the pressure tube. The piston divides the pressure tube into an upper working chamber and a lower working chamber both of which are filled with hydraulic fluid. Because the piston is able, through valving, to limit the flow of the hydraulic fluid between the upper and the lower working chambers when the shock absorber is compressed or extended, the shock absorber is able to produce a damping force which counteracts the vibration which would otherwise be transmitted from the unsprung portion to the sprung portion of the vehicle. In a dual-tube shock absorber, a fluid reservoir or reserve chamber is defined between the pressure tube and a reserve tube. A base valve is located between the lower working chamber and the reserve chamber to also produce a damping force which counteracts the vibrations which would otherwise be transmitted from the unsprung portion of the vehicle to the sprung portion of the automobile.

As described above, for a dual-tube shock absorber, the valving on the piston limits the flow of damping fluid between the upper and lower working chambers when the shock absorber is extended to produce a damping load. The valving on the base valve limits the flow of damping fluid between the lower working chamber and the reserve chamber when the shock absorber is compressed to produce a damping load. For a mono-tube shock absorber, the valving on the piston limits the flow of damping fluid between the upper and lower working chambers when the shock absorber is extended or compressed to produce a damping load. During driving, the suspension system moves in jounce (compression) and rebound (extension). During jounce movements, the shock absorber is compressed causing damping fluid to move through the base valve in a dual-tube shock absorber or through the piston valve in a mono-tube shock absorber. A damping valve located on the base valve or the piston controls the flow of damping fluid and thus the damping force created. During rebound movements, the shock absorber is extended causing damping fluid to move through the piston in both the dual-tube shock absorber and the mono-tube shock absorber. A damping valve located on the piston controls the flow of damping fluid and thus the damping force created.

In a dual-tube shock absorber, the piston and the base valve normally include a plurality of compression passages and a plurality of extension passages. During jounce movements in a dual-tube shock absorber, the damping valve or the base valve opens the compression passages in the base valve to control fluid flow and produce a damping load. A check valve on the piston opens the compression passages in the piston to replace damping fluid in the upper working chamber but this check valve does not contribute to the damping load. The damping valve on the piston closes the extension passages of the piston and a check valve on the base valve closes the extension passages of the base valve during a compression movement. During rebound movements in a dual-tube shock absorber, the damping valve on the piston opens the extension passages in the piston to control fluid flow and produce a damping load. A check valve on the base valve opens the extension passages in the base valve to replace damping fluid in the lower working chamber but this check valve does not contribute to the damping load.

In a mono-tube shock absorber, the piston normally includes a plurality of compression passages and a plurality of extension passages. The shock absorber will also include means for compensating for the rod volume flow of fluid as is well known in the art. During jounce movements in a mono-tube shock absorber, the compression damping valve on the piston opens the compression passages in the piston to control fluid flow and produce a damping load. The extension damping valve on the piston closes the extension passages of the piston during a jounce movement. During rebound movements in a mono-tube shock absorber, the extension damping valve on the piston opens the extension passages in the piston to control fluid flow and produce a damping load. The compression damping valve on the piston closes the compression passages of the piston during a rebound movement.

For most dampers, the damping valves are designed as a normal close/open valve even though some valves may include a bleed flow of damping fluid. Because of this close/open design, pressure oscillations can occur. These pressure oscillations can result in high frequency vibrations being generated by the shock absorber which can create an unwanted disturbance.

### SUMMARY

A valve assembly for a shock absorber includes a biasing member which produces an axisymmetrical load distribution to a valve plate. The valve plate closes a non-axisymmetrical pressure area. This geometry smoothes the transition from the valve being closed to the valve being open to eliminate and/or reduce the pressure oscillations associated with the normal close/open design of valving.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an illustration of an automobile having shock absorbers which incorporate the valve design in accordance with the present invention;

FIG. 2 is a side view, partially in cross-section of a dual-tube shock absorber from FIG. 1 which incorporates the valve design in accordance with the present invention;

FIG. 3 is an enlarged side view, partially in cross-section, of the piston assembly from the shock absorber illustrated in FIG. 2;

FIG. 4 is an enlarged side view, partially in cross-section of the base valve assembly from the shock absorber illustrated in FIG. 2;

FIGS. 5A and 5B are plan views of the piston from the piston assembly shown in FIG. 3;

FIGS. 6A and 6B are plan views of the valve body from the base valve shown in FIG. 5;

FIG. 7 is a plan view of a valve having a non-axisymmetrical pressure area in accordance with another embodiment of the present invention;

FIG. 8 is a plan view of a valve having a non-axisymmetrical pressure area in accordance with another embodiment of the present invention;

FIG. 9 is a side view, partially in cross-section, of a mono-tube shock absorber which incorporates the valve design in accordance with the present invention;

FIG. 10 is an enlarged side view, partially in cross-section of the piston assembly shown in FIG. 9; and

FIGS. 11A and 11B are plan views of the piston from the piston assembly of FIG. 10.

### DETAILED DESCRIPTION

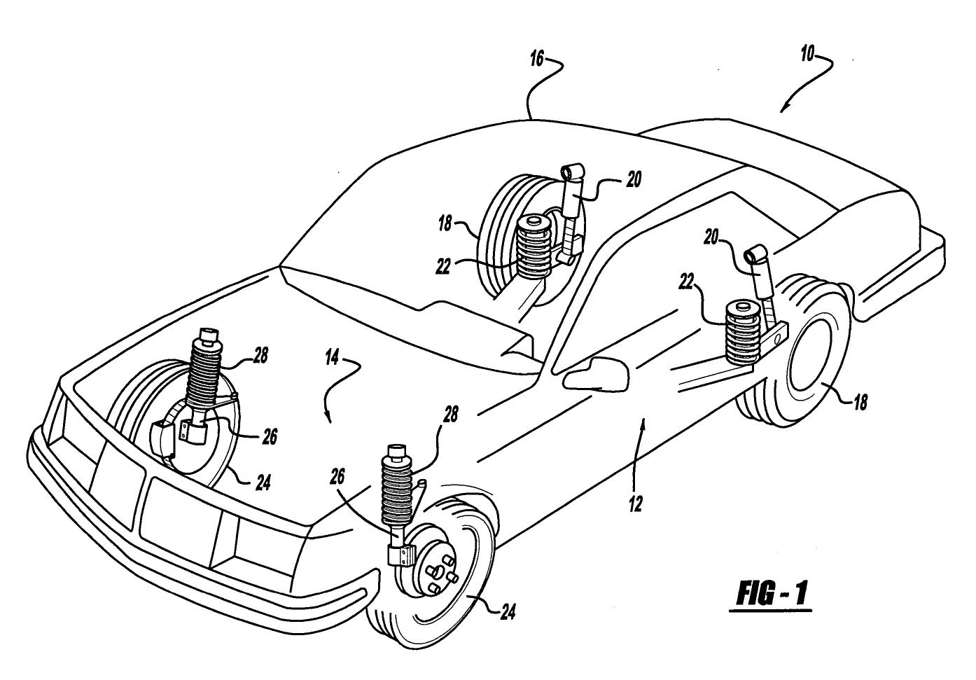

The following description is merely exemplary in nature and is not intended to limit the present disclosure, application, or uses. There is shown in FIG. 1 a vehicle incorporating a suspension system having shock absorbers, each of which incorporates a piston assembly in accordance with the present invention, and which is designated generally by the reference numeral 10. Vehicle 10 includes a rear suspension 12, a front suspension 14 and a body 16. Rear suspension 12 has a transversely extending rear axle assembly (not shown) adapted to operatively support a pair of rear wheels 18. The rear axle is attached to body 16 by means of a pair of shock absorbers 20 and by a pair of springs 22. Similarly, front suspension 14 includes a transversely extending front axle assembly (not shown) to operatively support a pair of front wheels 24. The front axle assembly is attached to body 16 by means of a pair of shock absorbers 26 and by a pair of springs 28. Shock absorbers 20 and 26 serve to dampen the relative motion of the unsprung portion (i.e., front and rear suspensions 12, 14) with respect to thee sprung portion (i.e., body 16) of vehicle 10. While vehicle 10 has been depicted as a passenger car having front and rear axle assemblies, shock absorbers 20 and 26 may be used with other types of vehicles or in other types of applications including, but not limited to, vehicles incorporating non-independent front and/or non-independent rear suspensions, vehicles incorporating independent front and/or independent rear suspensions or other suspension systems known in the art. Further, the term “shock absorber” as used herein is meant to refer to dampers in general and thus will include McPherson struts and other damper designs known in the art.

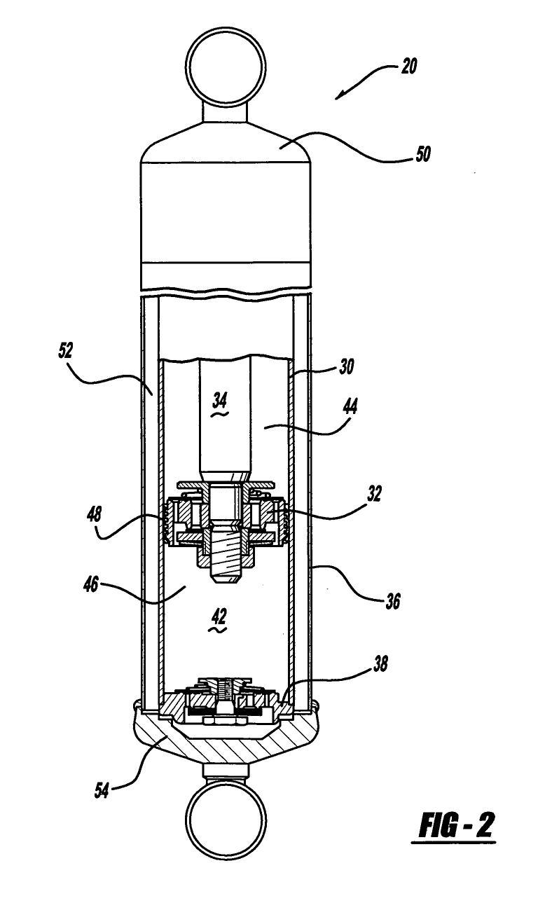

Referring now to FIG. 2, shock absorber 20 is shown in greater detail. While FIG. 2 illustrates only shock absorber 20, it is to be understood that shock absorber 26 also includes the valve design described below for shock absorber 20. Shock absorber 26 only differs from shock absorber 20 in the manner in which it is adapted to be connected to the sprung and unsprung masses of vehicle 10. Shock absorber 20 comprises a pressure tube 30, a piston assembly 32, a piston rod 34, a reserve tube 36 and a base valve assembly 38.

Pressure tube 30 defines a working chamber 42. Piston assembly 32 is slidably disposed within pressure tube 30 and divides working chamber 42 into an upper working chamber 44 and a lower working chamber 46. A seal 48 is disposed between piston assembly 32 and pressure tube 30 to permit sliding movement of piston assembly 32 with respect to pressure tube 30 without generating undue frictional forces as well as sealing upper working chamber 44 from lower working chamber 46. Piston rod 34 is attached to piston assembly 32 and extends through upper working chamber 44 and through upper end cap 50 which closes the upper end of pressure tube 30. A sealing system seals the interface between upper end cap 50, reserve tube 36 and piston rod 34. The end of piston rod 34 opposite to piston assembly 32 is adapted to be secured to the sprung mass of vehicle 10. Valving within piston assembly 32 controls the movement of fluid between upper working chamber 44 and lower working chamber 46 during movement of piston assembly 32 within pressure tube 30. Because piston rod 34 extends only through upper working chamber 44 and not lower working chamber 46, movement of piston assembly 32 with respect to pressure tube 30 causes a difference in the amount of fluid displaced in upper working chamber 44 and the amount of fluid displaced in lower working chamber 46. The difference in the amount of fluid displaced is known as the “rod volume” and it flows through base valve assembly 38.

Reserve tube 36 surrounds pressure tube 30 to define a fluid reservoir chamber 52 located between tubes 30 and 36. The bottom end of reserve tube 36 is closed by a base cup 54 which is adapted to be connected to the unsprung mass of vehicle 10. The upper end of reserve tube 36 is attached to upper end cap 50. Base valve assembly 38 is disposed between lower working chamber 46 and reservoir chamber 52 to control the flow of fluid between chambers 46 and 52. When shock absorber 20 extends in length, an additional volume of fluid is needed in lower working chamber 46 due to the “rod volume” concept. Thus, fluid will flow from reservoir chamber 52 to lower working chamber 46 through base valve assembly 38 as detailed below. When shock absorber 20 compresses in length, an excess of fluid must be removed from lower working chamber 46 due to the “rod volume” concept. Thus, fluid will flow from lower working chamber 46 to reservoir chamber 52 through base valve assembly 38 as detailed below.

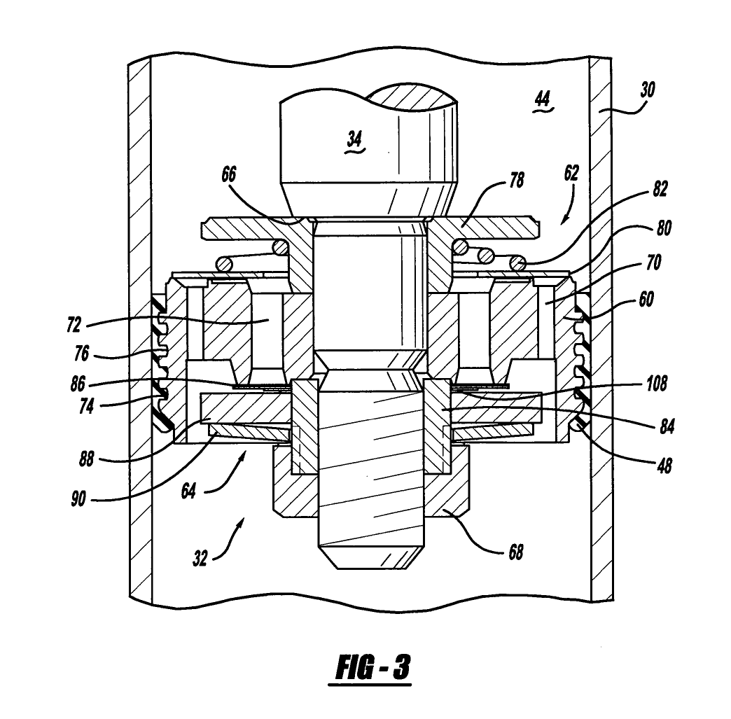

Referring now to FIG. 3, piston assembly 32 comprises a piston body 60, a compression valve assembly 62 and a rebound valve assembly 64. Compression valve assembly 62 is assembled against a shoulder 66 on piston rod 34. Piston body 60 is assembled against compression valve assembly 62 and rebound valve assembly 64 is assembled against piston body 60. A nut 68 secures these components to piston rod 34.

Piston body 60 defines a plurality of compression passages 70 and a plurality of rebound passages 72. Seal 48 includes a plurality of ribs 74 which mate with a plurality of annular grooves 76 to permit sliding movement of piston assembly 32.

Compression valve assembly 62 comprises a retainer 78, a valve disc 80 and a spring 82. Retainer 78 abuts shoulder 66 on one end and piston body 60 on the other end. Valve disc 80 abuts piston body 60 and closes compression passages 70 while leaving rebound passages 72 open. Spring 82 is disposed between retainer 78 and valve disc 80 to axisymmetrically bias valve disc 80 against piston body 60. During a compression stroke, fluid in lower working chamber 46 is pressurized causing fluid pressure to react against valve disc 80. When the fluid pressure against valve disc 80 overcomes the biasing load of spring 82, valve disc 80 separates from piston body 60 to open compression passages 70 and allow fluid flow from lower working chamber 46 to upper working chamber 44. Typically spring 82 only exerts a light axisymmetrical load on valve disc 80 and compression valve assembly 62 acts as a check valve between chambers 46 and 44. The damping characteristics for shock absorber 20 during a compression stroke are controlled by base valve assembly 38 which accommodates the flow of fluid from lower working chamber 46 to reservoir chamber 52 due to the “rod volume” concept. During a rebound stroke, compression passages 70 are closed by valve disc 80.

Rebound valve assembly 64 comprises a spacer 84, a plurality of valve discs 86, a retainer 88 and a Belleville spring 90. Spacer 84 is threadingly received on piston rod 34 and is disposed between piston body 60 and nut 68. Spacer 84 retains piston body 60 and compression valve assembly 62 while permitting the tightening of nut 68 without compressing either valve disc 80 or valve discs 86. Retainer 78, piston body 60 and spacer 84 provide a continuous solid connection between shoulder 66 and nut 68 to facilitate the tightening and securing of nut 68 to spacer 84 and thus to piston rod 34. Valve discs 86 are slidingly received on spacer 84 and abut piston body 60 to close rebound passages 72 while leaving compression passages 70 open. Retainer 88 is also slidingly received on spacer 84 and it abuts valve discs 86. Belleville spring 90 is assembled over spacer 84 and is disposed between retainer 88 and nut 68 which is threadingly received on spacer 84. Belleville spring 90 axisymmetrically biases retainer 88 against valve discs 86 and valve discs 86 against piston body 60. When fluid pressure is applied to discs 86, they will elastically deflect at the outer peripheral edge to open rebound valve assembly 64. A shim 108 is located between nut 68 and Belleville spring 90 to control the preload for Belleville spring 90 and thus the blow off pressure as described below. Thus, the calibration for the blow off feature of rebound valve assembly 64 is separate from the calibration for compression valve assembly 62.

During a rebound stroke, fluid in upper working chamber 44 is pressurized causing fluid pressure to react against valve discs 86. When the fluid pressure reacting against valve discs 86 overcomes the bending load for valve discs 86, valve discs 86 elastically deflect opening rebound passages 72 allowing fluid flow from upper working chamber 44 to lower working chamber 46. The strength of valve discs 86 and the size of rebound passages will determine the damping characteristics for shock absorber 20 in rebound. When the fluid pressure within upper working chamber 44 reaches a predetermined level, the fluid pressure will overcome the biasing load of Belleville spring 90 causing axial movement of retainer 88 and the plurality of valve discs 86. The axial movement of retainer 88 and valve discs 86 fully opens rebound passages 72 thus allowing the passage of a significant amount of damping fluid creating a blowing off of the fluid pressure which is required to prevent damage to shock absorber 20 and/or vehicle 10.

Referring to FIG. 4, base valve assembly 38 comprises a valve body 92, a compression valve assembly 94 and a rebound valve assembly 96. Compression valve assembly 94 and rebound valve assembly 96 are attached to valve body 92 using a bolt 98 and a nut 100. The tightening of nut 100 axisymmetrically biases compression valve assembly 94 towards valve body 92. Valve body 92 defines a plurality of compression passages 102 and a plurality of rebound passages 104.

Compression valve assembly 94 comprises a plurality of valve discs 106 that are axisymmetrically biased against valve body 92 by bolt 98 and nut 100. During a compression stroke, fluid in lower working chamber 46 is pressurized and the fluid pressure within compression passages 102 will eventually open compression valve assembly 94 by deflecting discs 106 in a manner similar to that described above for rebound valve assembly 64. Compression valve assembly 62 will allow fluid flow from lower working chamber 46 to upper working chamber 44 and only the “rod volume” will flow through compression valve assembly 94. The damping characteristics for shock absorber 20 are determined by the design of compression valve assembly 94 of base valve assembly 38.

Rebound valve assembly 96 comprises a valve disc 108 and an axisymmetrical valve spring 110. Valve disc 108 abuts valve body 92 and closes rebound passages 104. Valve spring 110 is disposed between nut 100 and valve disc 80 to axisymmetrically bias valve disc 108 against valve body 92. During a rebound stroke, fluid in lower working chamber 46 is reduced in pressure causing fluid pressure in reserve chamber 52 to react against valve disc 108. When the fluid pressure against valve disc 108 overcomes the biasing load of valve spring 110, valve disc 108 separates from valve body 92 to open rebound passages 104 and allow fluid flow from reserve chamber 52 to lower working chamber 46. Typically valve spring 110 exerts only a light axisymmetrical load on valve disc 108 and compression valve assembly 94 acts as a check valve between reserve chamber 52 and lower working chamber 46. The damping characteristics for a rebound stroke are controlled by rebound valve assembly 64 as detailed above.

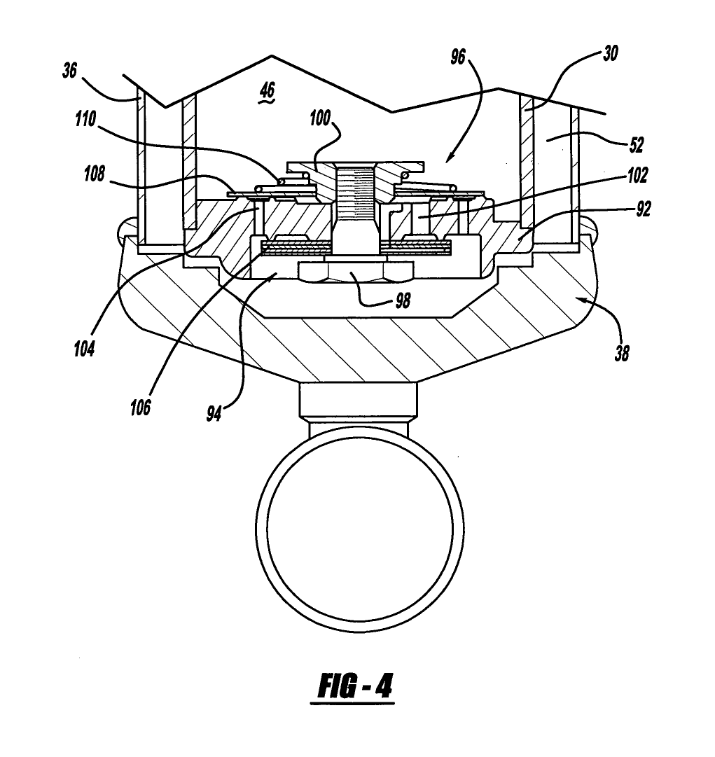

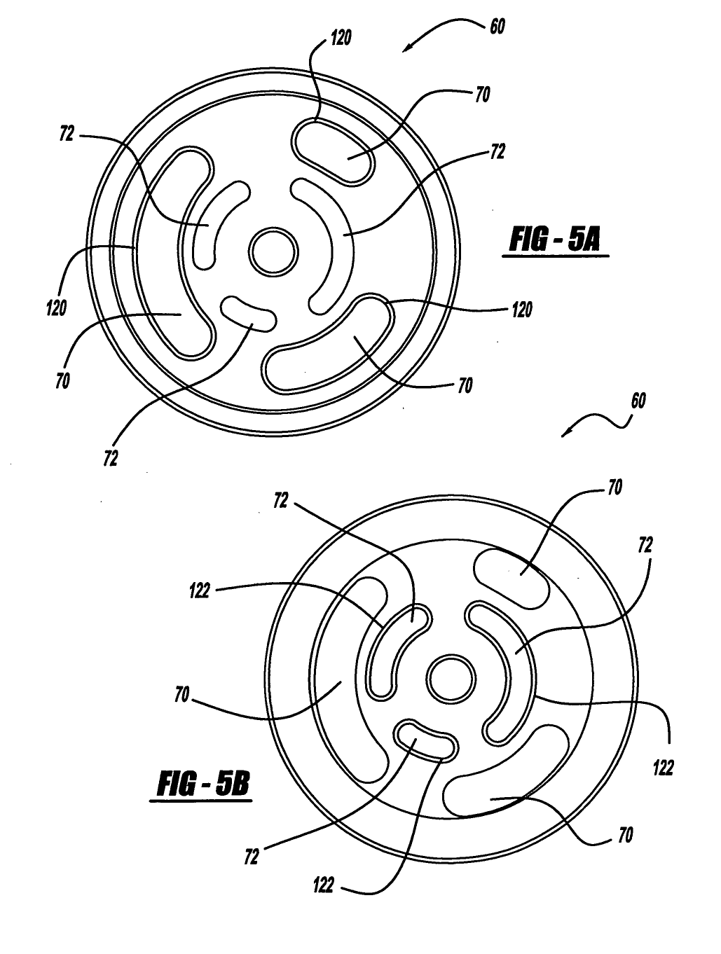

Referring now to FIGS. 5A and 5B, piston body 60 is illustrated. FIG. 5A illustrates the top of piston body 60 where the outlet of compression passages 70 are detailed and FIG. 5B illustrates the bottom of piston body 60 where the outlet of rebound passages 72 are detailed. As illustrated in FIGS. 5A and 5B, there are three compression passages 70 and three rebound passages 72. As illustrated in FIG. 5A, each compression passage 70 is a different size and each compression passage 70 has its own sealing land 120. Valve disc 80 engages each sealing land 120 to individually close each compression passage 70. Thus, the surface area on valve disc 80 defined by sealing lands 120 varies in relation to the circumferential location. During a compression stroke, fluid pressure within passages 70 reacts against valve disc 80. The fluid pressure in the largest cross-sectional sized passage 70 will deflect valve disc 80 first, followed by the second largest cross-sectional sized passage 70 followed by the smallest cross-sectional sized passage 70. This provides for a smooth transition between the closed position and the fully opened position of compression valve assembly 62. As illustrated in FIG. 5B, each rebound passage 72 is a different size and each rebound passage 72 has its own sealing land 122. Valve discs 86 engage each sealing land 120 to individually close each rebound passage 72. Thus, the surface area on valve disc 86 defined by sealing lands 122 varies in relation to the circumferential location. During a rebound stroke, fluid pressure within passages 72 reacts against valve discs 86. The fluid pressure in the largest cross-sectional sized passage 72 will deflect valve discs 86 first, followed by the second largest cross-sectional sized passage 72 followed by the smallest cross-sectional sized passage 72. This provides for a smooth transition between the closed position and the fully open position of rebound valve assembly 64.

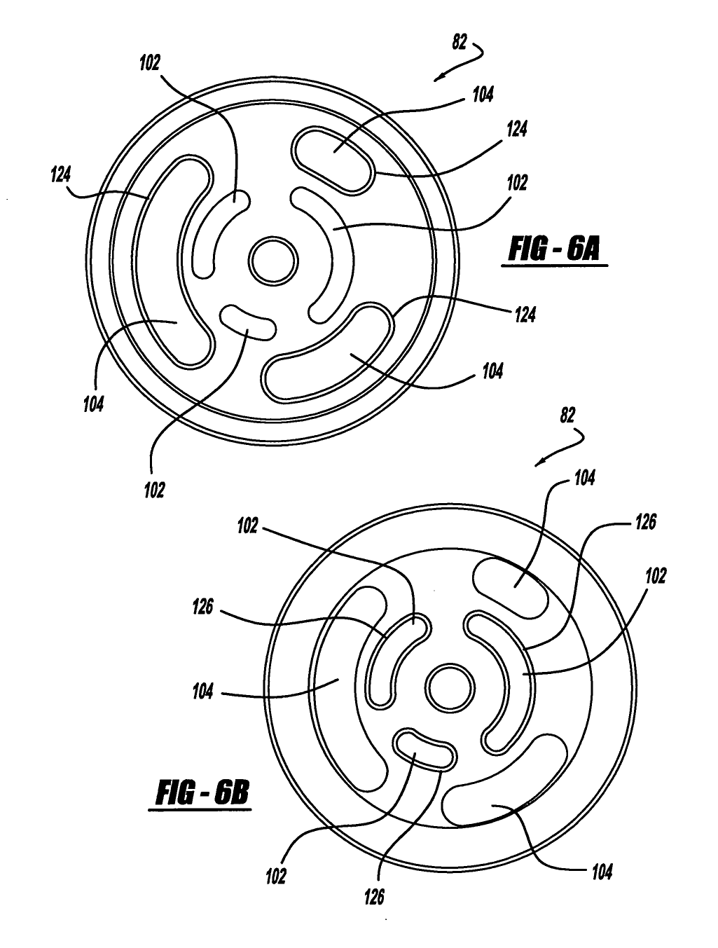

Referring now to FIGS. 6A and 6B, valve body 82 is illustrated. FIG. 6A illustrates the top of valve body 92 where the outlet of rebound passages 104 are detailed and FIG. 6B illustrates the bottom of valve body 92 where the outlet of compression passages 102 are detailed. As illustrated in FIGS. 6A and 6B, there are three compression passages 102 and three rebound passages 104. As illustrated in FIG. 6A, each rebound passage 104 is a different size and each rebound passage 104 has its own sealing land 124. Valve disc 108 engages each sealing land 124 to individually close each rebound passage 104. Thus, the surface area on valve disc 108 defined by sealing lands 124 varies in relation to the circumferential location. During a rebound stroke, fluid pressure within passages 104 reacts against valve disc 108. The fluid pressure in the largest cross-sectional sized passage 104 will deflect valve disc 108 first, followed by the second largest cross-sectional sized passage 104 followed by the smallest cross-sectional sized passage 104. This provides for a smooth transition between the closed position and the fully opened position of rebound valve assembly 96. As illustrated in FIG. 6B, each compression passage 102 is a different size and each compression passage 102 has its own sealing land 126. Valve discs 106 engage each sealing land 126 to individually close each compression passage 102. Thus, the surface area on valve disc 106 defined by sealing lands 126 varies in relation to the circumferential location. During a compression stroke, fluid pressure within passages 102 reacts against valve discs 106. The fluid pressure in the largest cross-sectional sized passage 102 will deflect valve discs 106 first, followed by the second largest cross-sectional sized passage 102 followed by the smallest cross-sectional sized passage 102. This provides for a smooth transition between the closed position and the fully open position of compression valve assembly 94.

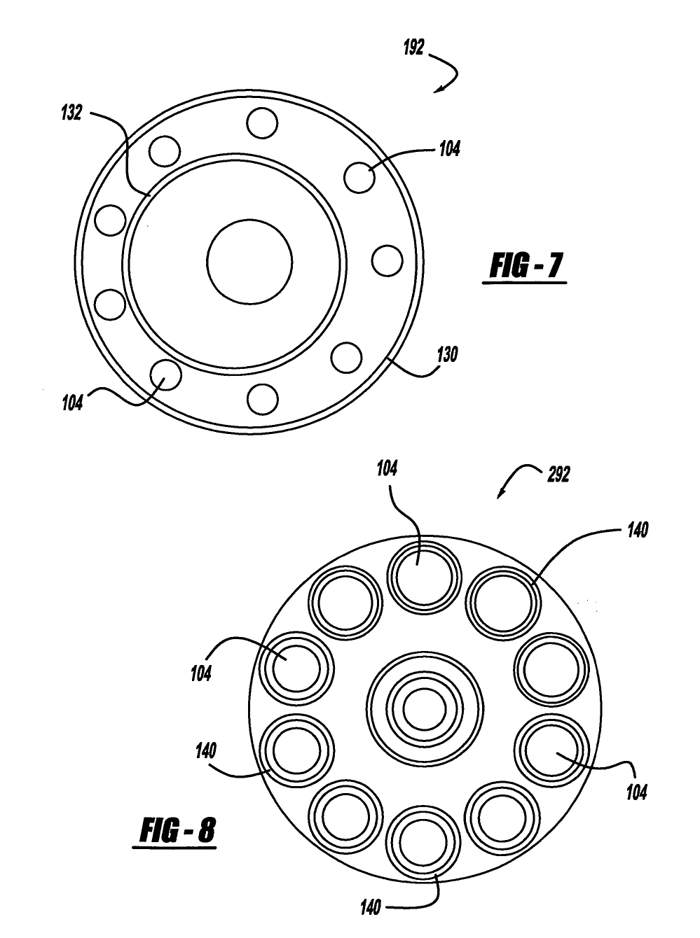

Referring now to FIG. 7, a valve body 192 is illustrated. While FIG. 7 illustrates only the top of valve body 192 and rebound passages 104, it is to be understood that the lower side of valve body 192 with compression passages 102, the top side of piston body 60 with compression passages 70 and the bottom side of piston body 60 with rebound passages 72 can incorporate the non-symmetrical design illustrated for valve body 192 and rebound passages 104.

As illustrated in FIG. 7 there are a plurality of equal sized rebound passages 104. An outer sealing land 130 and an inner sealing land 132 are disposed in an eccentric position with their centers being shifted such that a larger cross-sectional area for the fluid to react against valve disc 108 exists on one side of valve body 192. Thus, the surface area on valve disc 108 defined by sealing lands 130 and 132 varies in relation to the circumferential location. During a rebound stroke, fluid pressure acting against valve disc 108 occurs in an uneven manner due to the eccentric positioning of sealing lands 130 and 132. The fluid pressure in the largest cross-sectional area will deflect valve disc 108 first and eventually the fluid pressure will completely unseat valve disc 108 from sealing lands 130 and 132. This provides for a smooth transition between the closed position and the open position for the valve assembly.

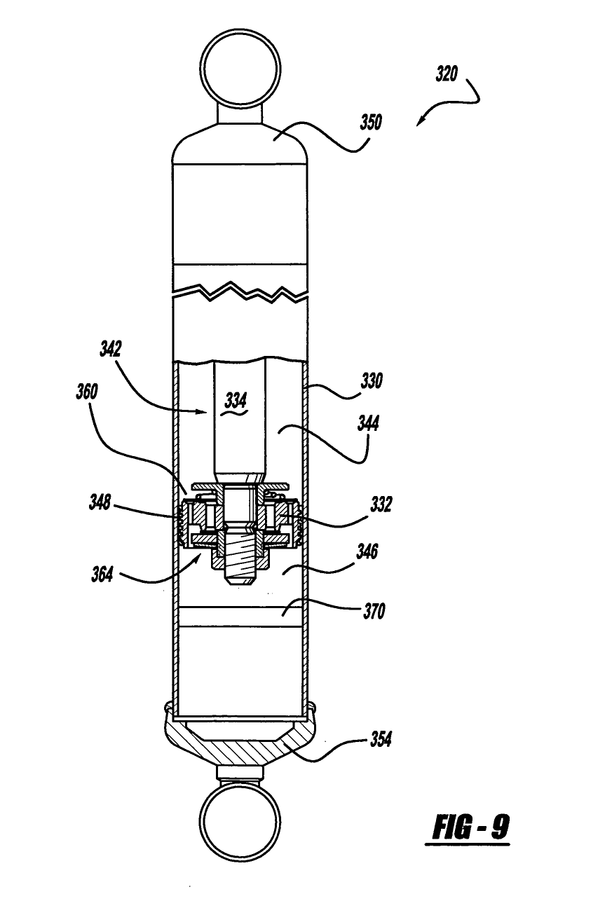

Referring now to FIG. 8, a valve body 292 is illustrated. While FIG. 8 illustrates only the top of valve body 292 and rebound passages 104, it is to be understood that the lower side of valve body 292 with compression passages 102, the top side of piston body 60 with compression passages 70 and the bottom side of piston body 60 with rebound passages 72 can incorporate the non-symmetrical design illustrated for valve body 292 and rebound passages 104.

As illustrated in FIG. 8, there are a plurality of different sized rebound passages 104. A separate sealing land 140 seals each individual passage 104. Valve disc 104 engages each sealing land 140 to individually close each rebound passage 104. Thus, the surface area on valve disc 104 defined by sealing lands 140 varies in relation to the circumferential location. During a rebound stroke, fluid pressure within passages 104 reacts against valve disc 104. The fluid pressure in the largest cross-sectional sized passage 104 will deflect valve disc 104 first, followed by the second largest cross-sectional sized passage 104, followed by the third largest cross-sectional sized passage and so on until valve disc 104 is fully separated from valve body 292. This provides for a smooth transition between the closed position and the fully open position of the valve assembly.

Referring now to FIG. 9-11B, a mono-tube shock absorber 320 in accordance with the present invention is illustrated. Shock absorber 320 can replace either shock absorber 20 or shock absorber 26 by modifying the way it is adapted to be connected to the sprung mass and/or the unsprung mass of the vehicle. Shock absorber 320 comprises a pressure tube 330, a piston assembly 332 and a piston rod 334.

Pressure tube 330 defines a working chamber 342. Piston assembly 332 is slidably disposed within pressure tube 330 and divides working chamber 342 into an upper working chamber 344 and a lower working chamber 346. A seal 348 is disposed between piston assembly 332 and pressure tube 330 to permit sliding movement of piston assembly 332 with respect to pressure tube 330 without generating undue frictional forces as well as sealing upper working chamber 344 from lower working chamber 346. Piston rod 334 is attached to piston assembly 332 and it extends through upper working chamber 344 and through an upper end cap or rod guide 350 which closes the upper end of pressure tube 330. A sealing system seals the interface between rod guide 350, pressure tube 330 and piston rod 334. The end of piston rod 334 opposite to piston assembly 332 is adapted to be secured to the sprung mass of vehicle 10. The end of pressure tube 330 opposite to rod guide 350 is closed by a base cup 354 which is adapted to be connected to the unsprung mass of vehicle 10.

A compression valve assembly 362 associated with piston assembly 332 controls movement of fluid between lower working chamber 346 and upper working chamber 344 during compression movement of piston assembly 332 within pressure tube 330. The design for compression valve assembly 362 controls the damping characteristics for shock absorber 320 during a compression stroke. An extension valve assembly 364 associated with piston assembly 332 controls movement of fluid between upper working chamber 344 and lower working chamber 346 during extension or rebound movement of piston assembly 332 within pressure tube 330. The design for extension valve assembly 364 controls the damping characteristics for shock absorber 320 during an extension or rebound stroke.

Because piston rod 334 extends only through upper working chamber 344 and not lower working chamber 346, movement of piston assembly 332 with respect to pressure tube 330 causes a difference in the amount of fluid displaced in upper working chamber 344 and the amount of fluid displaced in lower working chamber 346. The difference in the amount of fluid displaced is known as the “rod volume” and compensation for this fluid is accommodated by a piston 370 slidably disposed within pressure tube 330 and located between lower working chamber 346 and a compensation chamber 372. Typically compensation chamber 372 is filled with a pressurized gas and piston 370 moves within pressure tube 330 to compensate for the rod volume concept.

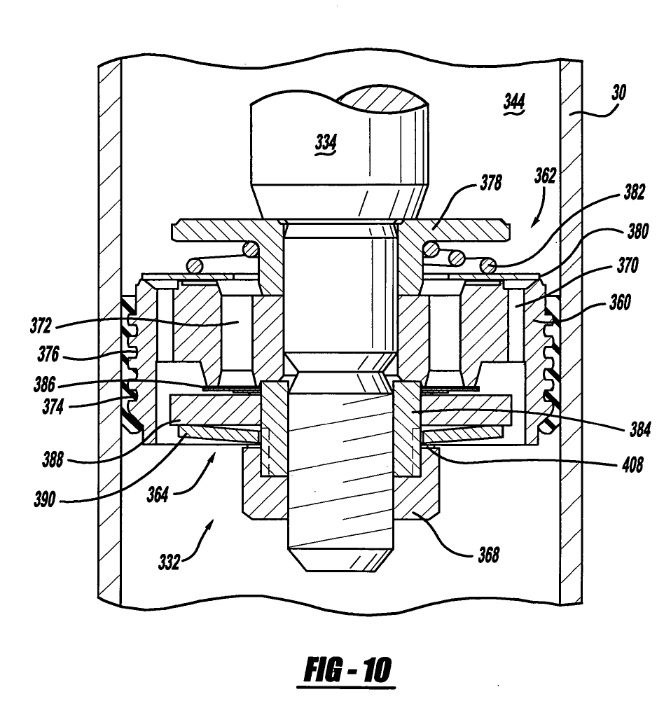

Referring now to FIG. 10, piston assembly 332 comprises a piston body 360, compression valve assembly 362 and rebound valve assembly 364. Compression valve assembly 362 is assembled against a shoulder 366 on piston rod 334. Piston body 360 is assembled against compression valve assembly 362 and rebound valve assembly 364 is assembled against piston body 360. A nut 368 secures these components to piston rod 334.

Piston body 360 defines a plurality of compression passages 370 and a plurality of rebound passages 372. Seal 348 includes a plurality of ribs 374 which mate with a plurality of annular grooves 376 to permit sliding movement of piston assembly 332.

Compression valve assembly 362 comprises a retainer 378, a valve disc 380 and a spring 382. Retainer 378 abuts shoulder 366 on one end and piston body 360 on the other end. Valve disc 380 abuts piston body 360 and closes compression passages 370 while leaving rebound passages 372 open. Spring 382 is disposed between retainer 378 and valve disc 380 to axisymmetrically bias valve disc 380 against piston body 360. During a compression stroke, fluid in lower working chamber 346 is pressurized causing fluid pressure to react against valve disc 380. When the fluid pressure against valve disc 380 overcomes the biasing load of spring 382, valve disc 380 separates from piston body 360 to open compression passages 370 and allow fluid flow from lower working chamber 346 to upper working chamber 344. The damping characteristics for shock absorber 320 during a compression stroke are controlled by compression valve assembly 362. During a rebound stroke, compression passages 370 are closed by valve disc 380.

Rebound valve assembly 364 comprises a spacer 384, a plurality of valve discs 386, a retainer 388 and a Belleville spring 390. Spacer 384 is threadingly received on piston rod 334 and is disposed between piston body 360 and nut 368. Spacer 384 retains piston body 360 and compression valve assembly 362 while permitting the tightening of nut 368 without compressing either valve disc 380 or valve discs 386. Retainer 378, piston body 360 and spacer 384 provide a continuous solid connection between shoulder 366 and nut 368 to facilitate the tightening and securing of nut 368 to spacer 384 and thus to piston rod 334. Valve discs 386 are slidingly received on spacer 384 and abut piston body 360 to close rebound passages 372 while leaving compression passages 370 open. Retainer 388 is also slidingly received on spacer 384 and it abuts valve discs 386. Belleville spring 390 is assembled over spacer 384 and is disposed between retainer 388 and nut 368 which is threadingly received on spacer 384. Belleville spring 390 axisymmetrically biases retainer 388 against valve discs 386 and valve discs 386 against piston body 360. When fluid pressure is applied to discs 386, they will elastically deflect at the outer peripheral edge to open rebound valve assembly 364. A shim 408 is located between nut 368 and Belleville spring 390 to control the preload for Belleville spring 390 and thus the blow off pressure as described below. Thus, the calibration for the blow off feature of rebound valve assembly 364 is separate from the calibration for compression valve assembly 362.

During a rebound stroke, fluid in upper working chamber 344 is pressurized causing fluid pressure to react against valve discs 386. When the fluid pressure reacting against valve discs 386 overcomes the bending load for valve discs 386, valve discs 386 elastically deflect opening rebound passages 372 allowing fluid flow from upper working chamber 344 to lower working chamber 346. The strength of valve discs 386 and the size of rebound passages will determine the damping characteristics for shock absorber 320 in rebound. When the fluid pressure within upper working chamber 344 reaches a predetermined level, the fluid pressure will overcome the biasing load of Belleville spring 390 causing axial movement of retainer 388 and the plurality of valve discs 386. The axial movement of retainer 388 and valve discs 386 fully opens rebound passages 372 thus allowing the passage of a significant amount of damping fluid creating a blowing off of the fluid pressure which is required to prevent damage to shock absorber 320 and/or vehicle 10.

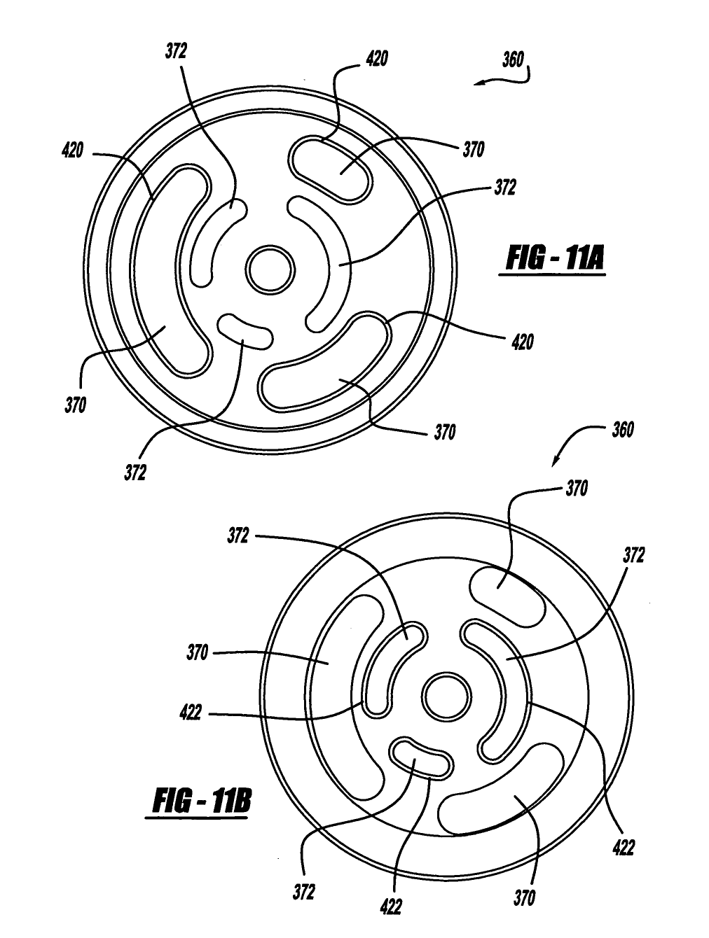

Referring now to FIGS. 11A and 11B, piston body 360 is illustrated. FIG. 11A illustrates the top of piston body 360 where the outlet of compression passages 370 are detailed and FIG. 11B illustrates the bottom of piston body 360 where the outlet of rebound passages 372 are detailed. As illustrated in FIGS. 11A and 11B, there are three compression passages 370 and three rebound passages 372. As illustrated in FIG. 11A, each compression passage 370 is a different size and each compression passage 370 has its own sealing land 420. Valve disc 380 engages each sealing land 420 to individually close each compression passage 370. Thus, the surface area on valve disc 380 defined by sealing lands 420 varies in relation to the circumferential location. During a compression stroke, fluid pressure within passages 370 reacts against valve disc 380. The fluid pressure in the largest cross-sectional sized passage 370 will deflect valve disc 380 first, followed by the second largest cross-sectional sized passage 370 followed by the smallest cross-sectional sized passage 370. This provides for a smooth transition between the closed position and the fully opened position of compression valve assembly 362. As illustrated in FIG. 11B, each rebound passage 372 is a different size and each rebound passage 372 has its own sealing land 422. Valve discs 386 engage each sealing land 420 to individually close each rebound passage 372. Thus, the surface area on valve disc 386 defined by sealing lands 422 varies in relation to the circumferential location. During a rebound stroke, fluid pressure within passages 372 reacts against valve discs 386. The fluid pressure in the largest cross-sectional sized passage 372 will deflect valve discs 386 first, followed by the second largest cross-sectional sized passage 372 followed by the smallest cross-sectional sized passage 372. This provides for a smooth transition between the closed position and the fully open position of rebound valve assembly 364.

What is claimed is:

1. A shock absorber comprising:
a pressure tube;
a valve assembly disposed within said pressure tube, said valve assembly comprising:
a valve body defining a plurality of first passages extending through said valve body;
a first plurality of sealing lands disposed on a first side of said valve body;
a first valve disc engaging said first plurality of sealing lands to close at least one of said first passages; wherein
a surface area on said first valve disc defined by said first plurality of sealing lands varies in relation to a circumferential location.

2. The shock absorber according to claim 1, wherein each of said plurality of first passages is encircled by a single sealing land, at least two of said first plurality of sealing lands defining a different surface area on said first valve disc.

3. The shock absorber according to claim 2, wherein each of said first plurality of sealing lands define a different surface area of said first valve disc.

4. The shock absorber according to claim 1, wherein at least two of said plurality of first passages have a different cross-sectional area.

5. The shock absorber according to claim 4, wherein each of said plurality of first passages is encircled by a single sealing land, at least two of said first plurality of sealing lands defining a different surface area on said first valve disc.

6. The shock absorber according to claim 5, wherein each of said first plurality of sealing lands define a different surface area of said first valve disc.

7. The shock absorber according to claim 1, wherein each of said plurality of first passages have a different cross-sectional area.

8. The shock absorber according to claim 7, wherein each of said plurality of first passages is encircled by a single sealing land, at least two of said first plurality of sealing lands defining a different surface area on said first valve disc.

9. The shock absorber according to claim 8, wherein each of said first plurality of sealing lands define a different surface area of said first valve disc.

10. The shock absorber according to claim 1, wherein said first plurality of sealing lands comprise an inner sealing land and an outer sealing land, said plurality of first passages being disposed between said inner and outer sealing lands.

11. The shock absorber according to claim 10, wherein a center of said inner sealing land is shifted from a center of said outer sealing land.

12. The shock absorber according to claim 1, further comprising:
a plurality of second passages extending through said valve body;
a second plurality of sealing lands disposed on a second side of said valve body;
a second valve disc engaging said second plurality of sealing lands to close at least one of said second passages.

13. The shock absorber according to claim 12, wherein a surface area on said second valve disc defined by said second plurality of sealing land varies in relation to a circumferential position.

14. The shock absorber according to claim 13, wherein each of said plurality of second passages is encircled by a single sealing land, at least two of said second plurality of sealing lands defining a different surface area on said second valve disc.

15. The shock absorber according to claim 14, wherein each of said second plurality of sealing lands define a different surface area of said second valve disc.

16. The shock absorber according to claim 13, wherein at least two of said plurality of second passages have a different cross-sectional area.

17. The shock absorber according to claim 16, wherein each of said plurality of second passages is encircled by a single sealing land, at least two of said second plurality of sealing lands defining a different surface area on said second valve disc.

18. The shock absorber according to claim 17, wherein each of said second plurality of sealing lands define a different surface area of said second valve disc.

19. The shock absorber according to claim 1, wherein each of said plurality of second passages have a different cross-sectional area.

20. The shock absorber according to claim 19, wherein each of said plurality of second passages is encircled by a single sealing land, at least two of said second plurality of sealing lands defining a different surface area on said second valve disc.

21. The shock absorber according to claim 20, wherein each of said second plurality of sealing lands define a different surface area of said second valve disc.

22. The shock absorber according to claim 13, wherein said second plurality of sealing lands comprise an inner sealing land and an outer sealing land, said plurality of first passages being disposed between said inner and outer sealing lands.

23. The shock absorber according to claim 22, wherein a center of said inner sealing land is shifted from a center of said outer sealing land.

24. The shock absorber according to claim 1, wherein said valve body is a piston body for a piston assembly slidingly disposed within said pressure tube.

25. The shock absorber according to claim 1, wherein said valve body is incorporated into a base valve assembly secured to said pressure tube.
